(19) United States
(12) Patent Application Publication
(10) Pub. No.: US 2025/0077947 A1
(43) Pub. Date: Mar. 6, 2025

(54) EXPLAINABLE MACHINE LEARNING CLASSIFIERS TRAINED ON PRIVACY-PRESERVING AGGREGATED DATA

(71) Applicant: FAIR ISAAC CORPORATION, Minneapolis, MN (US)

(72) Inventors: Gerald Fahner, Austin, TX (US); Christopher Allan Ralph, Toronto (CA)

(21) Appl. No.: 18/457,877

(22) Filed: Aug. 29, 2023

(51) Int. Cl. G06N 20/00

(52) U.S. Cl. CPC G06N 20/00

(57) ABSTRACT

A computer-implemented method for generating a classifier, comprising: receiving aggregated statistics objects, wherein the aggregated statistics objects comprise bin frequencies F0 and F1, wherein the bin frequencies F0 and F1 are calculated for each of a plurality of predictive features, conditioned on a target value being 0 or 1, respectively; bin-level covariances C0 and C1, wherein the bin-level covariances C0 and C1 are calculated for each pair of bins, conditioned on the target value being 0 or 1, respectively; feeding the aggregate statistics objects F0, F1, C0, and C1 into the classifier, wherein the classifier generates a score calculated as a sum of a plurality of flexible nonlinear shape functions applied to the plurality of predictive features, respectively; and training the classifier by fitting the plurality of shape functions to maximize a divergence for score separation between target value 0 and target value 1.

### TECHNICAL FIELD

The subject matter described herein relates to systems and methods for using Machine Learning (ML) technique to make predictions, for example generating explainable classifiers with aggregated data for different data owners.

### BACKGROUND

In recent years, Machine Learning (ML) models have gained widespread adoption across various industries for predictive purposes. For instance, in the retail sector, predictive models are utilized to forecast customer demand, optimize inventory levels, and personalize marketing campaigns, ultimately resulting in increased sales and improved customer satisfaction. In healthcare, predictive models play a crucial role in patient diagnosis, treatment recommendations, and disease outbreak predictions, contributing to enhanced patient care and proactive healthcare management. Furthermore, within the financial industry, ML models are employed for credit risk assessment, fraud detection, and market trend predictions, thereby enhancing decision-making processes and mitigating potential risks. These examples illustrate the substantial impact of predictive ML models, transforming industries and driving data-driven decision-making across diverse sectors.

Industry-specific ML models, or customized ML models, are attracting increasing attention due to their exceptional predictive capabilities in addressing the unique challenges and opportunities within specific sectors or within an organization. To generate a customized ML models, high quality and proprietary training data is generally utilized. Data privacy assumes critical significance in this context, considering that proprietary data often includes sensitive and personally identifiable information (PII) that requires protection. Additionally, safeguarding intellectual property is crucial as it may encompass trade secrets and innovative strategies, providing a competitive edge. Compliance with data protection regulations is also essential to avoid legal ramifications. Furthermore, access to proprietary data confers a significant competitive edge to businesses. It enables data-driven decision-making, informed strategic planning, and targeted marketing efforts, which in turn enhance operational efficiency and foster innovation. The escalating value of proprietary data underscores the critical importance of prioritizing data privacy and security.

However, in order to develop a customized ML model or classifier that suits the specific needs of a data owner's business, historical data is essential to train the model for specific tasks based on these past data points. This requirement can create conflicting goals between data privacy and effective classifier development, presenting challenges for both businesses and model developers. On one hand, data owners want to keep their data private to protect sensitive information and retain business competitive edge. On the other hand, model developers need access to sufficient and relevant data to create accurate and high-performing classifiers for the data owners.

Additionally, there are cases where providing explanations for model outputs becomes essential due to, for example, regulatory requirements. Moreover, these explanations can offer valuable insights for further model development in various scenarios. However, interpreting the results of certain machine learning models, such as deep neural networks, random forests, and support vector machines, can prove intricate and challenging. Additionally, these models generally require disaggregated data records for training, which can pose privacy and security risks to the data owners when sharing the proprietary data with external classifier developers. As described herein elsewhere, even after removing personally identifiable information (PII), privacy vulnerabilities can still exist. Synthetic data approaches offer some protection, but they may result in lower model/classifier performance and could expose proprietary data assets to potential attacks or theft if shared outside the data partner's firewall. Furthermore, data owners might also express concerns regarding the substantial strategic business intellectual property (IP) that can be conspicuously disclosed through certain high-fidelity synthetic datasets. These synthetic datasets have the ability to closely emulate a wide range of crucial patterns and relationships present in the actual data, which could hold strategic significance. Accordingly, what is needed are platform, systems and methods generating ML models/classifiers that are suitably constructed for particular data owners with proprietary data as training data set, such that the observations and/or outputs can be concisely explained, while the privacy of the proprietary training data can be carefully protected and the IP provided to model/classifier development teams can be minimized.

### SUMMARY

Methods, systems, and articles of manufacture, including computer program products, are provided for generating ML classifiers for data owners. In one aspect, there is provided a system. The system may include at least one processor and at least one memory. The at least one memory may store instructions that result in operations when executed by the at least one processor. The operations may include: receiving aggregated statistics objects, wherein the aggregated statistics objects comprise: bin frequencies F0 and F1, wherein the bin frequencies F0 and F1 are calculated for each of a plurality of predictive features, conditioned on a target value being 0 or 1, respectively; feeding the aggregate statistics objects into the classifier, wherein the classifier generates a score calculated as a sum of a plurality of flexible nonlinear shape functions applied to the plurality of predictive features, respectively; and training the classifier by fitting the plurality of shape functions to maximize a divergence for score separation between target value 0 and target value 1.

In another aspect, there is provided a method. The method includes: receiving aggregated statistics objects, wherein the aggregated statistics objects comprise: bin frequencies F0 and F1, wherein the bin frequencies F0 and F1 are calculated for each of a plurality of predictive features, conditioned on a target value being 0 or 1, respectively; feeding the aggregate statistics objects into the classifier, wherein the classifier generates a score calculated as a sum of a plurality of flexible nonlinear shape functions applied to the plurality of predictive features, respectively; and training the classifier by fitting the plurality of shape functions to maximize a divergence for score separation between target value 0 and target value 1.

In another aspect, there is provided a computer program product including a non-transitory computer readable medium storing instructions. The operations include receiving aggregated statistics objects, wherein the aggregated statistics objects comprise: bin frequencies F0 and F1, wherein the bin frequencies F0 and F1 are calculated for each of a plurality of predictive features, conditioned on a target value being 0 or 1, respectively; feeding the aggregate statistics objects into the classifier, wherein the classifier generates a score calculated as a sum of a plurality of flexible nonlinear shape functions applied to the plurality of predictive features, respectively; and training the classifier by fitting the plurality of shape functions to maximize a divergence for score separation between target value 0 and target value 1.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating a platform for generating classifiers, according to one or more implementations of the current subject matter;

FIG. 2 is a diagram illustrating some of the examples of aggregated statistics objects derived from raw data, according to one or more implementations of the current subject matter.

FIG. 3 is a process flow diagram illustrating a process for the platform and systems provided herein to develop a classifier with aggregated data received from a data partner, according to one or more implementations of the current subject matter.

FIG. 4 depicts a block diagram illustrating an example of a computing system, consistent with implementations of the current subject matter.

When practical, like labels are used to refer to same or similar items in the drawings.

### DETAILED DESCRIPTION

The details of one or more variations of the subject matter described herein are set forth in the accompanying drawings.

As discussed herein elsewhere, the conflicting goals between data privacy and effective classifier development present challenges for both data owners and model developers. In some instances, even after removing standard personally identifiable information (PII) such as names, phone numbers, and social security numbers (SSN) from a dataset, there remain potential privacy vulnerabilities. Records that appear de-identified can be susceptible to re-identification attacks, posing a significant privacy risk. Therefore, data partners seek improved methods for data security and privacy in the context of developing a classifier with proprietary training data. Synthetic data approaches offer some protection. However, using non-identifiable synthetic data has limitations, as it may lose some fidelity compared to the original data, which, in turn, may impact the performance of the classifier trained on synthetic data. Moreover, synthetic data, if mishandled, may be analyzed and utilized in ways beyond the intended classifier development, rendering the information within the synthetic data vulnerable to attacks or theft. For example, in epidemiology, classifiers may be trained to study the relationships between risk factors and disease outcomes. These classifiers enable researchers to analyze the impact of multiple factors while considering their additive contributions. Often, the training data may be structured data, such as electronic health records, disease registries, and survey data. These datasets frequently contain detailed information about patients' demographics, medical history, clinical diagnoses, treatment outcomes, and risk factors. Consequently, the training dataset may comprise sensitive personally identifiable information (PPI), such as names, phone numbers, and SSN, rendering it vulnerable to privacy risks. Even when PPI is removed from the electronic health data, it may still be re-identified by malicious actors using re-identification attacks, posing privacy concerns. Careful consideration of data privacy and security measures is vital when utilizing proprietary training data to develop classifiers in various fields, including epidemiology, to ensure the protection of sensitive information and maintain data integrity.

Moreover, when utilizing machine learning and classifier development strategies involving disaggregated synthetic data, there can arise tensions between safeguarding valuable strategic intellectual property (IP) inherent in the synthetic datasets and achieving the requisite high-fidelity emulation of actual data. Such high fidelity associated with synthetic data is often crucial for the effectiveness of various machine learning approaches in crafting top-tier models. For instance, an adversary could exploit a high-fidelity synthetic dataset for diverse purposes beyond the intended customization of classifiers according to business requisites. In essence, with the synthetic data approach to machine learning, data owners might inadvertently disclose more IP than necessary for the primary objective of constructing a specific model or classifier.

To address these concerns, provided herein are platform, methods and systems that may generate customized classifiers without compromising the privacy and/or the IP of the training data. This may be achieved by training classifiers with an anonymized and highly aggregated data set that is difficult or impossible to be re-identified, which may only contains minimally required information tailored to the task of developing a specific classifier, and yet provides the same amount information with the same level of specificity to train a classifier, and result in a classifier as if the classifier is trained on the raw data so to ensure unencumbered performance of the classifier.

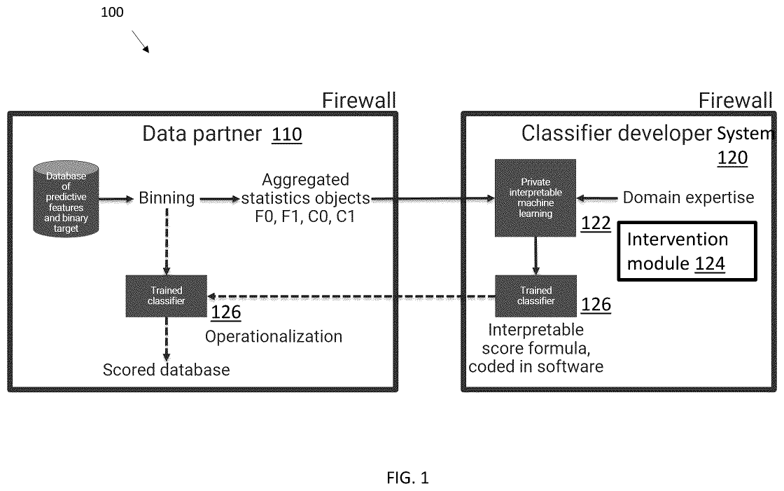

FIG. 1 is a diagram illustrating a platform 100 for generating classifiers, according to one or more implementations of the current subject matter. As shown in FIG. 1, the data partner 110 may protect the proprietary data (e.g., dataset stored in database 112) within a corporate firewall. The dataset may comprise data with predictive features and binary targets. In some implementations, the dataset may be pre-processed for classifier development. For example, the data partner 110 may perform data sampling by taking a random subset of the collected dataset. The data partner 110 may also conduct a feature generation process to extract relevant predictive features from the collected dataset; these predictive features may serve as candidate predictive features for classifier development. In some implementations, the data partners may also define the target variable. For instance, the target variable may be defined as a binary variable, where “1” indicates a positive outcome and “0” indicates a negative outcome.

The predictive features can be binned using binning algorithms, such as standard binning algorithms. The total number of bins (across all candidate features) is denoted as B. In certain implementations, the data partner 110 may generate or calculate aggregated statistics objects from the proprietary data, wherein these aggregated statistics objects may comprise bin frequencies and bin-level covariances. Additionally, in some implementations, the data partner 110 may generate or calculate bin frequencies for the candidate predictive features, based on the condition of the target value (i.e., the target variable) being either 1 or 0. For instance, bin frequencies F0={f0_1, f0_2, . . . , f0_B} are generated for observations where the target value is 0, while bin frequencies F1={f1_1, f1_2, . . . , f1_B} are generated for observations where the target value is 1. In certain implementations, the data partners 110 may generate or calculate all pairwise covariances between the B bins based on the condition of the target value. As an example, bin-level covariances C0={c0(1,1), c0(1,2), . . . , c0(B,B)} are generated for observations where the target value is 0; and bin-level covariances C1={c1(1,1), c1(1,2), . . . , c1(B,B)} are generated for observations where the target value is 1.

In some implementations, as depicted in FIG. 1, the data partner 110 can transmit the aggregated statistics objects F0, F1, C0, and C1 to a classifier developer system 120. In some implementations, the aggregated statistics objects F0, F1, C0, and C1 might be transmitted across one or more firewalls. Aggregated statistics objects, including F0, F1, C0, and C1, are capable of preserving privacy and the data owner's IP due to their summarization of data at a higher level, thereby offering general insights into the data while refraining from revealing sensitive individual-level information or revealing informative relationships and patterns between features that are not required for developing a high-performing classifier. For instance, the aggregation of data can obscure individual identities, thereby posing challenges in linking the statistics back to specific individuals.

Aggregated data solely unveils patterns at the group or population level, refraining from divulging particulars about individuals. In other words, aggregated data represents an anonymized dataset. In contrast to a de-identified dataset achieved through de-identification processes, which could potentially be re-identified utilizing diverse data processing techniques, this anonymized dataset-comprising the aggregated statistics objects-might not be reversed or re-identified. Consequently, data owners and/or data partners 110 encounter no regulatory or reputational risks when sharing these aggregated statistics objects with a classifier developer.

As shown in FIG. 1, in some implementation, the classifier developer system 120 may receive the aggregated statistics objects F0, F1, C0, and C1 from the data partner 110, and train a ML classifier with the aggregated statistics objects. In some implementation, the classifier 122 may be configured to generate a score calculated as a sum of multiple flexible nonlinear shape functions applied to the predictive features. For example, a score may be defined as f1(x1)+ . . . +fP(xP), wherein x denotes the predictive features, and f( ) denotes flexible nonlinear shape functions that are fitted to the data. This classifier 122 thus may have an architecture of Generalized Additive Models (GAMs). In some implementations, each function f( ) is represented as a weighted linear combination of B-splines with weights called B-spline coefficients. The fitting objective for fitting the shape functions is to maximize Jeffrey's divergence (i.e., a symmetrization of Kullback-Leibler divergence). The divergence is indicative of the separation achieved by the score, and maximizing the divergence results in strong separation between the score distributions conditional on target values 0 and 1. Subject to reasonable assumptions that the conditional score distributions are Gaussian with equal variances it can be shown that the aggregated statistics objects F0, F1, C0 and C1 provide the necessary and sufficient information required to optimize the B-spline coefficients, and hence optimize the shape functions, resulting in strong score separation between the 0's and the 1's. The GAM-based classifier 122 may be developed by iteratively adding additional predictive features and their associated shape functions to the classifier 122 subject to a stopping criterion based on a predetermined threshold for score separation improvement. In some implementations, the stopping criterion may be defined as a point where no further score separation improvement can be achieved. In some implementations, the stopping criterion may be defined as a point where a less than x % score separation improvement is achieved by adding additional predictive features, wherein x may be 5, 4, 3, 2, 1, 0.5, 0.4, 0.3, 0.2, 0.1, 0.01, 0.001 etc. Once the improvement is smaller than the predefined threshold x %, the training for the classifier 122 may be paused or terminated.

In some implementations, the development of the GAM-based classifier 122 may be automated. In some implementations, the development of the classifier 122 may be an iterative process in which a human domain expert (model developer) interprets the classifier 122 at each step and may intervene if a shape function contravenes intuition and/or legal requirements that may exist in certain regulated application areas of machine learning. In some implementations, the development of the classifier 122 may be an iterative process in which an intervention module 124 may automatically interpret the classifier 122, and may intervene based on pre-defined rules. These rules may be configurable by classifier developers 120 and may be modularized. These rules may capture regulatory requirements associated with a particular industry and/or Machine Learning itself. The intervention module 124 may automate the intervention process by automatically intervene during the classifier development process.

In some implementations, an intervention may take the form of rejecting a predictive feature from the model altogether. For example, a predictive feature in epidemiology studies may be previous healthcare spending associated with patients. A domain expert may recognize that healthcare spending can be a socially biased indicator of health and may in response exclude healthcare spending-related features from model development, to avoid these data biases creeping into the model. In another example, a predictive feature in epidemiology studies may be residential addresses associated with patients. By excluding the exact residential addresses from the classifier training/developing process, the researchers can still study the impact of geographic locations without risking the direct identification of individuals.

In some implementations, an intervention may take the form of constraining a shape function to have a desired shape, for example being increasing or decreasing. This can be achieved by constrained optimization of Jeffrey's divergence whereby constraints are applied to the B-spline coefficients. For example, in epidemiology study, there may be an expectation that a physiological response is increasing with a drug dosage. But variability and biases in the training data may lead to some unexplainable up and down wiggles of the unconstrained shape function. In response, a model developer/domain expert may constrain the relationship to be increasing as scientifically expected. In some implementations, the platform 100 may provide a visualization of the fitted shape functions as 2-dimensional plots for classifier interpretation. In some implementations, the visualization of fitted shape functions as 2-dimensional plots may also aid in constraints specification for the optimization process. As shown in FIG. 1, the trained classifier 126 may be transmitted across the firewalls to the data partner 110. In some implementations, the trained classifier 126 may be handed to the data partner 110 in a form of shape function plots, so to enhance their understanding of the classifier and to build their trust in the model. In some implementations, data partner 110 may deploy the trained classifier 126 to classify new, disaggregated observations within their firewall. In some implementations, the output of the trained classifier 126 may generate additional candidate predictive features, and those features and/or associated values may be binned and may provide additional data points for further development for the classifier 126.

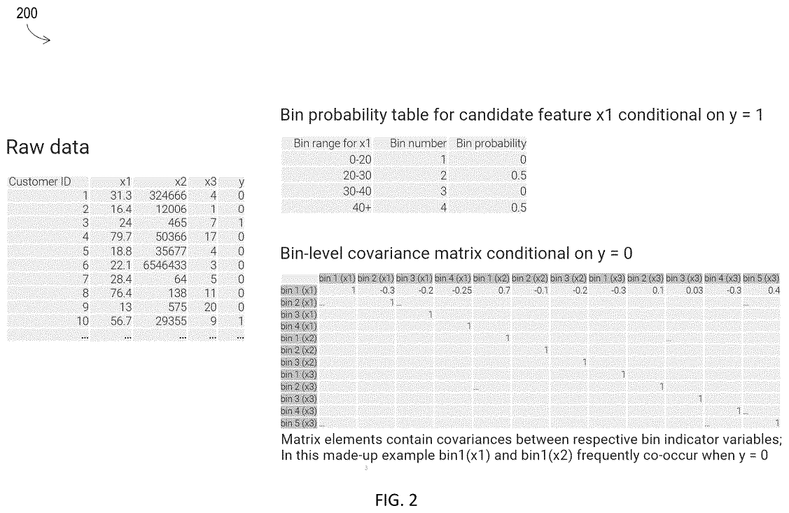

FIG. 2 is a diagram illustrating some of the examples of aggregated statistics objects (on the right hand side) derived from raw data. As shown in FIG. 2, the raw data may comprise a number of data entries, e.g., from 1 to 10 and going on under the column of Customer ID, and each of the data entries may comprise multiple predictive features x1, x2, and x3, and a target value y. In some implementations, the target value y is a binary value of 0 and 1.

This raw data may be binned for each of the predictive features x1, x2, and x3 to generate a bin probability table. In some implementations, the bin probability table may be replaced by a bin frequency table, which offers the same amount of information mathematically for the purpose of training a GAM-based classifier. For each predictive feature x1, x2, and x3, two bin probabilities/frequencies may be calculated, one conditioned on the target value y=1, and the other conditioned on the target value y=0, and results in F1 and F0 respectively. As shown in the bin probability table, for predictive feature x1, conditioned on the target value y=1, bin probability/bin frequency may be generated/calculated. Next, for each pair of the multiple pairs of bins, a covariance matrix may be generated, conditioned on y=0 or 1, which will result in C0 and C1, respectively. As shown in FIG. 2, the diagonal of the covariance matrix is automatically filled with value 1, as the covariance of a bin to itself equals to value 1. For other covariance between the bins in a pair of bins, standard covariance calculation may be utilized to generate the covariance matrix.

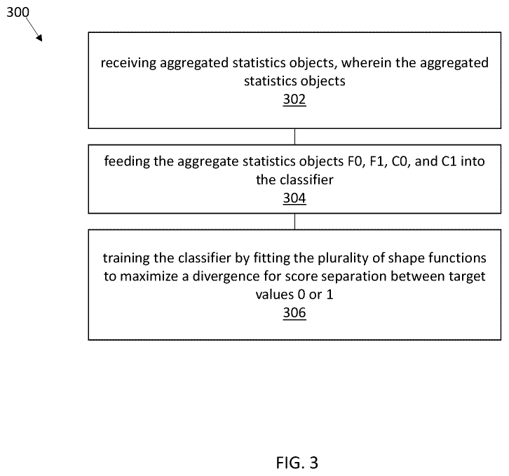

FIG. 3 is a process flow diagram illustrating a process 300 for the platform and systems provided herein to develop a classifier with data received from a data partner. In some implementations, the process may start with operation 302, wherein the system (e.g., classifier developer system 120 as shown in connection with FIG. 1) may receive aggregated statistics objects from the data partners 110. As described herein elsewhere, the aggregated statistics objects may comprise bin frequencies F0 and F1, wherein the bin frequencies F0 and F1 are calculated for each of a plurality of predictive features, conditioned on a target value being 0 or 1, respectively; bin-level covariances C0 and C1, wherein the bin-level covariances C0 and C1 are calculated for each pair of bins, conditioned on the target value being 0 or 1, respectively. Since these statistics objects are generated and/or calculated within the data partner's firewall, it may eliminate the concerns associated with sharing proprietary data and oversharing IP outside of an organization. The process 300 may then proceed to operation 304, wherein the classifier developer system 120 may feed the aggregated statistics objects into the classifier, e.g., the classifier 122 shown in connection with FIG. 1. In some implementations, the classifier may generate a score calculated as a sum of multiple nonlinear shape functions applied to the predictive features, respectively. For example, as described herein elsewhere, a score may be defined as f1(x1)+ . . . +fP(xP), wherein x denotes the predictive features, and f( ) denotes flexible nonlinear shape functions that are fitted to the data. This classifier 122 thus may have an architecture of Generalized Additive Models (GAMs). Next, the process 300 may proceed to operation 306, wherein the system 120 may train the classifier 122 by fitting the shape functions to maximize a divergence for score separation between target values 0 or 1. In some implementations, each function f( ) is represented as a weighted linear combination of B-splines with weights called B-spline coefficients. The fitting objective for fitting the shape functions is to maximize Jeffrey's divergence (i.e., a symmetrization of Kullback-Leibler divergence). The divergence is indicative of the separation achieved by the score, and maximizing the divergence results in strong separation between the score distributions conditional on target values 0 and 1. Subject to reasonable assumptions that the conditional score distributions are Gaussian with equal variances it can be shown that the aggregated statistics objects F0, F1, C0 and C1 provide the necessary and sufficient information required to optimize the B-spline coefficients, and hence optimize the shape functions, resulting in strong score separation between the 0's and the 1's. In other words, the aggregated statistics objects F0, F1, C0 and C1, in concert with one another, provide a data set that is functionally and/or mathematically equivalent to the raw data in terms on training this GAM-based classifier 122, because the fitting process is subject to this fitting objective to maximize the divergence for score separation between target values 0 and target value 1. In some implementations, the fitting objective for fitting the shape functions is to determine the B-splines coefficients that would maximize the divergence. To apply the constrained optimization, additional mathematical conditions or inequality constraints may be added to the optimization problem that determines the B-spline coefficients. These constraints are designed to guide the optimization process to find solutions that satisfy the desired properties of the shape functions while maximizing the divergence for score separation between the target values 0 and 1.

Additionally, in operation 306, the system 122 may add additional predictive features and their associated shape functions to the classifier 122 subject to a stopping criterion based on a predetermined threshold for score separation improvement. In some implementations, the stopping criterion may be defined as a point where no further score separation improvement can be achieved. In some implementations, the stopping criterion may be defined as a point where a less than x % score separation improvement is achieve by adding additional predictive features. Once the improvement is smaller than the predefined threshold x %, the training for the classifier 122 may be paused or terminated.

### Use Case

The systems and methods provided herein may be used in various industries wherein the proprietary data is carefully handled by the data owners. In one implementation, for example, in an epidemiological study, the aim is to predict disease outcomes based on patient information and risk factors using machine learning techniques. The raw data may comprise electronic patient records containing various predictive features, such as age, gender, medical history, lifestyle habits, and geographic location. The target variable may be binary, with a value of 1 indicating the presence of the disease and 0 for the absence of the disease. To preserve privacy and ensure data security, data pre-processing techniques may apply, including aggregation and anonymization, to protect sensitive information while deriving meaningful insights. For example, in some implementations, the data partner may optionally pre-process the patient records by removing personally identifiable information (PII) like names, SSNs, and exact addresses. By excluding this sensitive information, the risk of re-identification and privacy breaches is significantly reduced. The remaining patient information is used as predictive features, and the target variable is derived based on the disease diagnosis. It is worth noting that removing the PII is not required for performing the process described herein, as the later data processing may effective mask the PII altogether. In some implementations, the data owner may remove any direct PPI, such as name, phone number, address that are associated with the data as a standard practice in a pre-processing step. As described herein elsewhere, this pre-processed data (or, also referred to as coarsened data) may contain sufficient information for classifier development. Indirect PPI, such as age, gender, and ethnicity would not need to be removed.

Next, the classifier developer system may provide instructions to the data partners to aggregate the training data. For example, the manner of aggregating the training data may depend on the model selection, i.e., the classifier architecture. For example, for making the prediction regarding disease outcomes based on patient information and risk factors, the classifier developer system may determine that using a Generalized Additive Model (GAM) to make the predictions is appropriate, because GAM stand out for the ease of interpretation while allowing for flexible nonlinear fitting of the data and strong predictive performance. Accordingly, the classifier developer system may provide instructions to the data partners to aggregate the training data by binning the predictive features and generate aggregated statistics objects. The data partners may then follow the instructions and aggregate the training data to generate aggregated statistics objects. In some implementations, using standard binning algorithms, the data partner may calculate bin frequencies for each predictive feature conditional on the disease outcome (target variable). For patients with the disease (target=1), bin frequencies F1 are generated, and for patients without the disease (target=0), bin frequencies F0 are derived. Additionally, the data partner may calculate pairwise covariances between the bins for both target values, resulting in bin-level covariances C1 and C0. It is worth noting that the aggregated statistics objects provide just enough insight into to the raw data to build the desired classifier model, without revealing PPI or extra information associated with the raw data, because the predictive features are binned to only show frequencies. For example, consider a scenario where a domain expert identifies that the data source comprises diverse population segments with varying potential responses to a particular treatment. There could be a first segment composed of children, a second segment of individuals aged 18-40, and a third segment comprising older patients. In reaction to this insight, a segmented system employing three Generalized Additive Models (GAMs) is formulated by applying the specialized process mentioned earlier to each of the three segments, addressing each segment's distinct characteristics one at a time.

The data partner may then hand the aggregated statistics objects to classifier developer system for model training and developing. With the aggregated statistics objects F0, F1, C0, and C1 in hand, the classifier developer system may train the GAM-based classifier to predict disease outcomes. The GAM-based classifier utilizes the aggregated statistics to optimize the B-spline coefficients, enabling strong score separation between disease presence and absence. Additionally, due to the high-interpretable nature of GAM-based classifiers, the interpretability allows epidemiologists to gain insights into the impact of different risk factors on disease occurrence.

In some implementations, the development process necessitates only the utilization of statistics objects F0 and F1, excluding C0 and C1. This selective approach aids in minimizing the amount of information shared by the data owner with the model developer. However, it's important to note that such a simplified classifier might not yield the same level of accuracy since it lacks insights into potential correlations among the predictive features. Instead, it could lean on an assumption of uncorrelated bins given the disease outcome, often referred to as the “Naïve Bayes” assumption. Importantly, our method facilitates the creation of such classifiers when the data owner prefers to withhold information about bin correlations. It might be highly desirable where it is known that the correlations among the predictive features are not of importance.

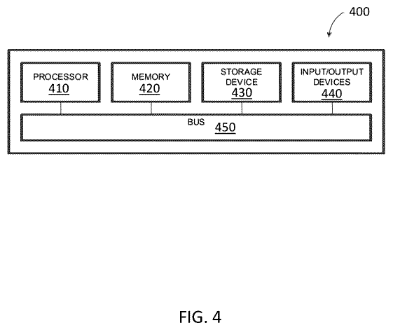

FIG. 4 depicts a block diagram illustrating a computing system 400 consistent with implementations of the current subject matter. Referring to FIGS. 1-4, the computing system 400 can be used to implement the platform 100, the classifier developer system 120, the intervention module 124, and/or any components therein.

As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The computing system 400 may additionally or alternatively include a graphic processing unit (GPU), such as for image processing, and/or an associated memory for the GPU. The GPU and/or the associated memory for the GPU may be interconnected via the system bus 450 with the processor 410, the memory 420, the storage device 430, and the input/output devices 440. The memory associated with the GPU may store one or more images described herein, and the GPU may process one or more of the images described herein. The GPU may be coupled to and/or form a part of the processor 410. The processor 410 is capable of processing instructions for execution within the computing system 400. Such executed instructions can implement one or more components of, for example, the diffusion system 100, the machine learning engine 110, the first machine learning model 120, the second machine learning model 125, and/or the like. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method for generating a classifier, comprising:
receiving aggregated statistics objects, wherein the aggregated statistics objects comprise:
bin frequencies F0 and F1, wherein the bin frequencies F0 and F1 are calculated for each of a plurality of predictive features, conditioned on a target value being 0 or 1, respectively;
feeding the aggregate statistics objects into the classifier, wherein the classifier generates a score calculated as a sum of a plurality of flexible nonlinear shape functions applied to the plurality of predictive features, respectively; and
training the classifier by fitting the plurality of shape functions to maximize a divergence for score separation between target value 0 and target value 1.

2. The method of claim 1, wherein the aggregated statistics objects further comprise bin-level covariances C0 and C1, wherein the bin-level covariances C0 and C1 are calculated for each pair of bins, conditioned on the target value being 0 or 1, respectively.

3. The method of claim 2, wherein the shape function is a weighted linear combination of B-splines using B-spline coefficients.

4. The method of claim 3, wherein a fitting objective for fitting the plurality of shape functions is to determine the B-splines coefficients that maximize the divergence.

5. The method of claim 3, further comprising intervening by applying constraints on the B-spline coefficients of the plurality of shape functions.

6. The method of claim 3, further comprising intervening by rejecting one or more predictive features.

7. The method of claim 1, further comprising iteratively adding additional predictive features and their associated shape functions to the classifier subject to a stopping criterion based on a predetermined threshold for score separation improvement.

8. The method of claim 1, further comprising providing a visualization of the fitted shape functions as 2-dimensional plots for classifier interpretation.

9. The method of claim 1, wherein the aggregated statistic objects are generated by segmented training data, wherein the training data is segmented base at least in part on one or more heterogeneous behavior.

10. A computer program product comprising a non-transient machine-readable medium storing instructions that, when executed by at least one programmable processor, cause the at least one programmable processor to perform operations comprising:
receiving aggregated statistics objects, wherein the aggregated statistics objects comprise:
bin frequencies F0 and F1, wherein the bin frequencies F0 and F1 are calculated for each of a plurality of predictive features, conditioned on a target value being 0 or 1, respectively;
feeding the aggregate statistics objects into the classifier, wherein the classifier generates a score calculated as a sum of a plurality of flexible nonlinear shape functions applied to the plurality of predictive features, respectively; and
training the classifier by fitting the plurality of shape functions to maximize a divergence for score separation between target value 0 and target value 1.

11. The computer program product of claim 10, wherein the aggregated statistics objects further comprise bin-level covariances C0 and C1, wherein the bin-level covariances C0 and C1 are calculated for each pair of bins, conditioned on the target value being 0 or 1, respectively.

12. The computer program product of claim 11, wherein the shape function is a weighted linear combination of B-splines using B-spline coefficients.

13. The computer program product of claim 12, wherein a fitting objective for fitting the plurality of shape functions is to determine the B-splines coefficients that maximize the divergence.

14. The computer program product of claim 10, wherein the operations further comprises iteratively adding additional predictive features and their associated shape functions to the classifier subject to a stopping criterion based on a predetermined threshold for score separation improvement.

15. A system comprising:
a programmable processor, and
a non-transient machine-readable medium storing instructions that, when executed by the processor, cause the at least one programmable processor to perform operations comprising:
receiving aggregated statistics objects, wherein the aggregated statistics objects comprise:
bin frequencies F0 and F1, wherein the bin frequencies F0 and F1 are calculated for each of a plurality of predictive features, conditioned on a target value being 0 or 1, respectively;
feeding the aggregate statistics objects into the classifier, wherein the classifier generates a score calculated as a sum of a plurality of flexible nonlinear shape functions applied to the plurality of predictive features, respectively; and
training the classifier by fitting the plurality of shape functions to maximize a divergence for score separation between target value 0 and target value 1.

16. The system of claim 15, wherein the aggregated statistics objects further comprise bin-level covariances C0 and C1, wherein the bin-level covariances C0 and C1 are calculated for each pair of bins, conditioned on the target value being 0 or 1, respectively.

17. The system of claim 16, wherein the shape function is a weighted linear combination of B-splines using B-spline coefficients.

18. The system of claim 17, wherein a fitting objective for fitting the plurality of shape functions is to determine the B-splines coefficients that maximize the divergence.

19. The system of claim 15, wherein the operations further comprises iteratively adding additional predictive features and their associated shape functions to the classifier subject to a stopping criterion based on a predetermined threshold for score separation improvement.

20. The system of claim 15, wherein the operations further comprises providing a visualization of the fitted shape functions as 2-dimensional plots for classifier interpretation.
